(19) United States
(12) Patent Application Publication
(10) Pub. No.: US 2023/0296179 A1
(43) Pub. Date: Sep. 21, 2023

(54) METHOD AND APPARATUS FOR REDUCING CAVITATION IN A FLUID END

(71) Applicants: William J. Mallery, Wooster, OH (US); Roy J. Dunlop, Bridgeport, WV (US); Jon Ryan Mallery, Mansfield, OH (US)

(72) Inventors: William J. Mallery, Wooster, OH (US); Roy J. Dunlop, Bridgeport, WV (US); Jon Ryan Mallery, Mansfield, OH (US)

(21) Appl. No.: 18/182,761

(22) Filed: Mar. 13, 2023

Related U.S. Application Data
(60) Provisional application No. 63/320,755, filed on Mar. 17, 2022.

(51) Int. Cl. F16K 1/42; F04B 53/10; F16K 15/04; F16K 25/00

(52) U.S. Cl. CPC F16K 1/42; F04B 53/1002; F16K 15/044; F16K 15/042; F16K 25/005

(57) ABSTRACT

A ball valve assembly for a fracturing (frac) fluid end. The ball valve assembly includes a seat that is adapted to engaged with the frac fluid end inside of at least one chamber defined by the frac fluid end. The ball valve assembly also includes a seal that is operably engaged with the seat to prevent fluid from escaping around the seat. The ball valve assembly also includes a ball valve that is operably engageable inside of the seat. During operation, the ball valve is moveable between a seated position and a disengaged position relative to the seat via at least plunger of the frac fluid end to allow the fluid to travel from an intake chamber of the frac fluid end towards a discharge chamber of the frac fluid end.

### REFERENCE TO RELATED APPLICATIONS

This application claims the benefit of U.S. Provisional Application Ser. No. 63/320,755, filed on Mar. 17, 2022; the disclosure of which is incorporated herein by reference.

### TECHNICAL FIELD

This present disclosure is directed to fracturing pumps (or frac pumps) or slurry pumps. More particularly, this present disclosure is directed to valve assemblies in fluid ends of frac or slurry pumps. Specifically, this present disclosure is directed to ball slurry valve assemblies in fluid ends of slurry pumps.

### BACKGROUND ART

Fracturing pumps (also called “frac pumps”), slurry pumps, and similar pumps are used in various industries such as oil and gas industries for boring well into geological rock forms to extract trapped oil and gas in geological rock formations. Other industries that may use these frac or slurry pumps include municipal storage water or dewatering industries, pipeline industry, groundwater and storm water management, refinery industries, chemical plant solutions, and other various types of industries for extracting or transporting fluid.

Currently, frac pumps include a power end (also called “frac power end”) and a fluid end (also called “frac fluid end”) where the frac power end is capable of generating low and high pressures inside of the frac fluid end to pump frac fluid. During fracturing operations, the frac power end generates power to move various reciprocating plungers in and out of the frac fluid end to draw fracturing fluid (also called “frac fluid”) from a fluid reservoir and to inject it down said frac fluid into a wellbore. The frac fluid is generally a slurry fluid that is a chemical mixture (e.g., mixture of sand and water) used in well drilling operations to increase the quantity of hydrocarbons that be extracted from the desired well. During these operations, these slurry pumps experience the stress of harsh hydraulic fracturing fluids and high-pressure pumping at a continuous rate for long periods of time. As such, these slurry pumps, specifically the frac fluid ends, experience both low and high pressures differentials at continuous rates when pumping frac fluid during fracturing operations.

To combat these pressure differentials inside of the frac fluid end, current frac fluid ends in the market use certain valve assemblies, specifically stem guided valves and wing guided valves. While these valves may combat the varying pressures inside of the frac fluid ends, the stem guided valves and the wing guided valves have several drawbacks that are detrimental to the frac fluid ends and the slurry pumps as a whole.

As for the stem guided valves, these stem guide valves have a tendency to be stuck or hung-up in the slurry mixture that are drawn through the frac fluid ends, which, inevitably, causes the stem guided valves to be immovable. Once these stem guided valves are immovable, the slurry pumps lose their prime and fail to pump these slurry mixtures through the frac fluid end efficiently due to the lack of the stem guide valves moving between sealed positions and unsealed positions. Moreover, these stem guided valves also create highly turbulent flow of frac fluid inside of the frac fluid ends which lead to excessive wear on the valves, the seats, and the frac fluid ends. This highly turbulent flow combined with the direction of flow from the stem guided valves may also contribute to cavitation inside of the frac fluid ends. Such cavitation caused by these stem guide valves could lead to cracking or fissuring in the frac fluid ends thus accelerating the life of the slurry pumps.

As for wing guided valves, these wing guided valves have a tendency to be wedged or lodged in their respective seats of the valve assemblies when moving between seated positions and disengaged positions. Specifically, these wing guided valves have wings or arms extending from the valve that may cause this wedging or lodging when these wing guided valves are seated at an angle inside respective seats. Once these wing guided valves are wedged and/or lodged in seats, the slurry pumps lose their prime and fail to pump slurry mixtures through the frac fluid end efficiently due to the lack of the wing guide valves moving between sealed positions and unsealed positions. Moreover, these wing guided valves also create highly turbulent flow of frac fluid inside of the frac fluid ends which lead to excessive wear on the valves, the seats, and the frac fluid ends. This highly turbulent flow combined with the direction of flow from the wing guided valves may also contribute to cavitation inside of the frac fluid ends. Such cavitation caused by these wing guide valves could lead to cracking or fissuring in the frac fluid ends thus accelerating the life of the slurry pumps.

### SUMMARY OF THE INVENTION

The presently disclosed slurry valve assembly provides slurry pumps with a valve that is capable of reducing turbulent flow and cavitation of frac fluid drawn through the frac fluid ends. The disclosed slurry valve assembly may also reduce the loss of prime or pump efficiency of slurry pumps since the valve of this slurry valve assembly may be seated at any orientation with a respective seat of the slurry valve assembly during fracturing operations. As such, the slurry valve assembly disclosed herein addresses some of the inadequacies of previously known slurry valve assemblies provided in frac fluid ends of slurry pumps.

In one aspect, an exemplary embodiment of the present disclosure may provide a slurry pump. The slurry pump includes an intake chamber and a discharge chamber. The slurry pump also includes a seat operably engaged inside of one of the intake chamber and the discharge chamber of a fluid end of the slurry pump. The slurry pump also includes an insert operably engaged inside of the seat. The slurry pump also includes a ball valve operably engaged inside of the insert and the seat, where the ball valve is moveable between a seated position and a disengaged position relative to the seat and the insert for allowing fluid to traveling from the intake chamber to the discharge chamber. The ball valve is also free of any retention member operably engaged inside of a fluid end of a slurry pump.

This exemplary embodiment or another exemplary embodiment may further provide a seal operably engaged with the seat remote from the insert. This exemplary embodiment or another exemplary embodiment may further provide that the seat further comprises a circumferential groove defined in an exterior surface of the seat, where the circumferential groove is configured to allow the seal to operably engaged with the seat inside of said circumferential groove. This exemplary embodiment or another exemplary embodiment may further provide a circumferential slot defined in the seat, and a circumferential extension extending away from the insert, where the circumferential extension is configured to operably engaged with the seat inside of the circumferential slot. This exemplary embodiment or another exemplary embodiment may further provide that the seat further comprises an annular collar having an interior fillet extending downwardly from a top surface of the annular collar to an upper shoulder of the annular collar, where the interior fillet defines a diameter of about thirty degrees between the top surface of the annular collar and the upper shoulder of the annular collar. This exemplary embodiment or another exemplary embodiment may further provide that the seat further comprises an annular collar having an interior fillet extending downwardly from a top surface of the annular collar to an upper shoulder of the annular collar, where the interior fillet defines a diameter of about forty degrees between the top surface of the annular collar and the upper shoulder of the annular collar.

In another aspect, an exemplary embodiment of the present disclosure may provide a method. The method comprises the steps of retracting at least one plunger of a plurality of plungers away from a fluid end of a slurry pump; disengaging a ball valve of at least one intake valve of the slurry pump to force a volume of liquid through the at least one intake valve body; inserting the at least one plunger of a plurality of plungers into the fluid end of the slurry pump; disengaging a ball valve of at least one discharge valve body of the slurry pump to force the volume of liquid through the at least one discharge valve body; and discharging the volume of liquid through a discharge port defined in the fluid end of the slurry pump.

In yet another aspect, an exemplary embodiment of the present disclosure may provide a ball valve assembly for a fracturing (frac) fluid end. The ball valve assembly may include a seat that is adapted to engaged with the frac fluid end inside of at least one chamber defined by the frac fluid end. The ball valve assembly may also include a seal that is operably engaged with the seat to prevent fluid from escaping around the seat. The ball valve assembly may also include a ball valve that is operably engageable inside of the seat. The ball valve is moveable between a seated position and a disengaged position relative to the seat via at least plunger of the frac fluid end to allow the fluid to travel from an intake chamber of the frac fluid end towards a discharge chamber of the frac fluid end.

This exemplary embodiment or another exemplary embodiment may further include an insert operably engaged inside of the seat and spaced apart from the seal; wherein the insert is configured to contact the ball valve inside of the seat for preventing the ball valve from being wedged inside of the seat when moving between the seated position and the disengaged position. This exemplary embodiment or another exemplary embodiment may further include a first material forming the seat; and a second material forming the insert; wherein the first material and the second material are different materials. This exemplary embodiment or another exemplary embodiment may further include that the first material is a metal material and the second material is a resilient material made of Neoprene or urethane. This exemplary embodiment or another exemplary embodiment may further include that the seat further comprises: an annular collar having an interior fillet extending downwardly from a top surface of the annular collar to an upper shoulder of the annular collar; wherein the annular collar is configured to catch the ball valve when the ball valve moves from the disengaged position to the seated position. This exemplary embodiment or another exemplary embodiment may further include a diameter defined by the interior fillet of the annular collar; wherein the diameter of the interior fillet is between about 30 degrees up to 40 degrees. This exemplary embodiment or another exemplary embodiment may further include a diameter defined by the interior fillet of the annular collar; wherein the diameter of the interior fillet is approximately 40 degrees. This exemplary embodiment or another exemplary embodiment may further include a circumferential slot defined in the seat and positioned vertically below the annular collar; and a circumferential extension extending away from the insert; wherein the circumferential extension is configured to operably engaged with the seat inside of the circumferential slot. This exemplary embodiment or another exemplary embodiment may further include an upper shoulder of the seat positioned vertically below the annular collar; a lower shoulder of the seat vertically opposite to the upper shoulder and positioned vertically below the annular collar and the upper shoulder; and a recessed portion defined between the upper shoulder and the lower shoulder; wherein the insert operably engages with the upper shoulder and the lower shoulder and is housed inside of the recessed portion. This exemplary embodiment or another exemplary embodiment may further include a circumferential groove defined in an exterior surface of the seat; wherein the circumferential groove is configured to allow the seal to operably engaged with the seat inside of said circumferential groove. This exemplary embodiment or another exemplary embodiment may further include a retaining bar adapted to engage with the fracturing fluid end inside of the at least one chamber; and a biaser operably engaged with the retaining bar and the ball valve; wherein the biaser is configured to bias the ball valve at the seated position. This exemplary embodiment or another exemplary embodiment may further include a biaser adapted to engage with a plug of the fracturing fluid end and the ball valve; wherein the biaser is configured to bias the ball valve at the seated position. This exemplary embodiment or another exemplary embodiment may further include that the seat further comprises: a top open end; a bottom open end vertically opposite to the top open end; and a passageway defined therebetween; wherein when the ball valve is in the seated position, portions of the ball valve extend outwardly from the top open end and the bottom open end.

In yet another aspect, an exemplary embodiment of the present disclosure may provide a method. The method may include steps of: engaging at least one ball valve assembly with an intake manifold of a fracturing (frac) fluid end of a slurry pump; engaging at least another ball valve assembly with a discharge manifold of the frac fluid end of the slurry pump; transitioning a ball valve of the at least one ball valve assembly from a seated positon to a disengaged position relative to a seat of the at least one ball valve assembly when at least one plunger of a plurality of plungers retracts from the frac fluid end; transitioning a ball valve of the at least another ball valve assembly from a seated positon to a disengaged position relative to a seat of the at least another ball valve assembly when the at least one plunger inserts into the frac fluid end; and discharging a volume of fluid through the at least one ball valve assembly and the at least another ball valve assembly.

This exemplary embodiment or another exemplary embodiment may further include steps of transitioning the ball valve of the at least one ball valve assembly from the disengaged positon to the seated position relative to the seat of the at least one ball valve assembly when the at least one plunger retracts from the frac fluid end; wherein the seat includes an annular collar having an interior fillet extending downwardly from a top surface of the annular collar to an upper shoulder of the annular collar; wherein the interior fillet defines a diameter at approximately 40 degrees. This exemplary embodiment or another exemplary embodiment may further include a step of contacting the ball valve of the at least one ball valve assembly with an insert of the at least one ball valve assembly when the ball valve of the at least one ball valve assembly is provided in the seated position. This exemplary embodiment or another exemplary embodiment may further include a step of transitioning the ball valve of the at least another ball valve assembly from the disengaged positon to the seated position relative to the seat of the at least another ball valve assembly when the at least one plunger retracts from the frac fluid end; wherein the seat includes an annular collar having an interior fillet extending downwardly from a top surface of the annular collar to an upper shoulder of the annular collar; wherein the interior fillet defines a diameter at approximately 40 degrees. This exemplary embodiment or another exemplary embodiment may further include a step of contacting the ball valve of the at least another ball valve assembly with an insert of the at least another ball valve assembly when the ball valve of the at least another ball valve assembly is provided in the seated position. This exemplary embodiment or another exemplary embodiment may further include a step of biasing the ball valve of the at least one ball valve assembly, via a biaser of the at least one ball valve assembly, towards the seat of the at least one ball valve assembly. This exemplary embodiment or another exemplary embodiment may further include a step of biasing the ball valve of the at least another ball valve assembly, via a biaser of the at least another ball valve assembly, towards the seat of the at least another ball valve assembly.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a top, front, right side isometric perspective view of a fracturing (frac) pump.

FIG. 2 is a partial sectional view of the slurry pump with first and second valve assemblies in accordance with an aspect of the present disclosure, wherein the first and second valve assemblies are provided in a seated position.

FIG. 3 is a top, front, right side isometric perspective view of the valve assembly.

FIG. 3A is a cross-sectional view of the valve assembly taken in the direction of line 3A-3A in FIG. 3.

FIG. 4 is an exploded view of the valve assembly shown in FIG. 3.

FIG. 4A is an exploded cross-sectional view of the valve assembly taken in the direction of line 4A-4A in FIG. 4.

FIG. 5A is an operational view of the slurry pump, wherein the first valve assembly transitions from the seated position to a disengaged position, via the pressure differential created by a plunger of the slurry pump, to allow fluid to enter into a frac fluid end of the slurry pump.

FIG. 5B is another operational view similar to FIG. 5A, but the second valve assembly transitions from the seated position to the disengaged position, via the pushing force created by the plunger of the slurry pump, to allow fluid to exit through a discharge manifold.

FIG. 6A is a cross-sectional view of another valve assembly.

FIG. 6B is an exploded cross-sectional view of the valve assembly shown in FIG. 6A.

Similar numbers refer to similar parts throughout the drawings.

### DETAILED DESCRIPTION

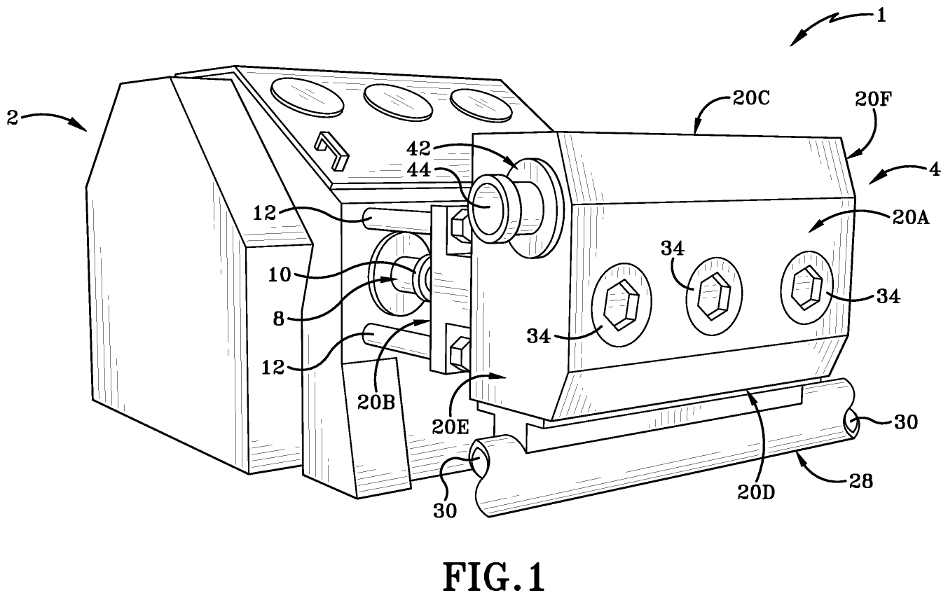

FIG. 1 illustrates a fracturing pump (hereinafter “frac pump”) or a slurry pump that is generally referred to as 1. The frac pump 1 described and illustrated herein may be used for various well stimulation techniques for fracking liquids at high pressures for the creating of wellbores in a desired rock formation to extract fluids from geological rock formations. Such extractable fluids include natural gas, petroleum fluids, brine, and other various extractable fluids from geological rock formations. The frac pump 1 may also be used in other various industries for various pumping and extraction techniques including municipal storage water storage or dewatering industries, pipeline industry, groundwater and storm water management, refinery industries, chemical plant solutions, and other various types of industries for pumping or transporting fluids.

In the illustrated embodiment, the frac pump 1 is constructed in a triplex configuration using three pistons or plunger, which is described in more detail. While the frac pump 1 is illustrated in a triplex structural configuration, any suitable structural configuration may be used herein. In one exemplary embodiment, a slurry pump may be constructed in a quintuplex configuration using five pistons or plunger.

As illustrated in FIG. 1, the frac pump 1 includes a fracturing power end (hereinafter “frac power end”) generally referred to as 2. The frac power end 2 of the frac pump 1 is configured to provide suitable power and pressure to allow frac fluid into the frac pump 1 for creating a wellbore via the frac pump 1. Additionally, the frac pump 1 includes a fracturing fluid end (hereinafter “frac fluid end”) generally referred to as 3. The frac fluid end 3 is operably engaged with the frac power end 2 where the frac fluid end 3 is in fluid communication with the frac power end 2. The frac fluid end 3 is configured to receive the frac fluid into the frac pump 1, via the pressure created by the frac power end 2, and to pump said frac fluid down into the wellbore for extracting hydrocarbon fluids from inside of the wellbore.

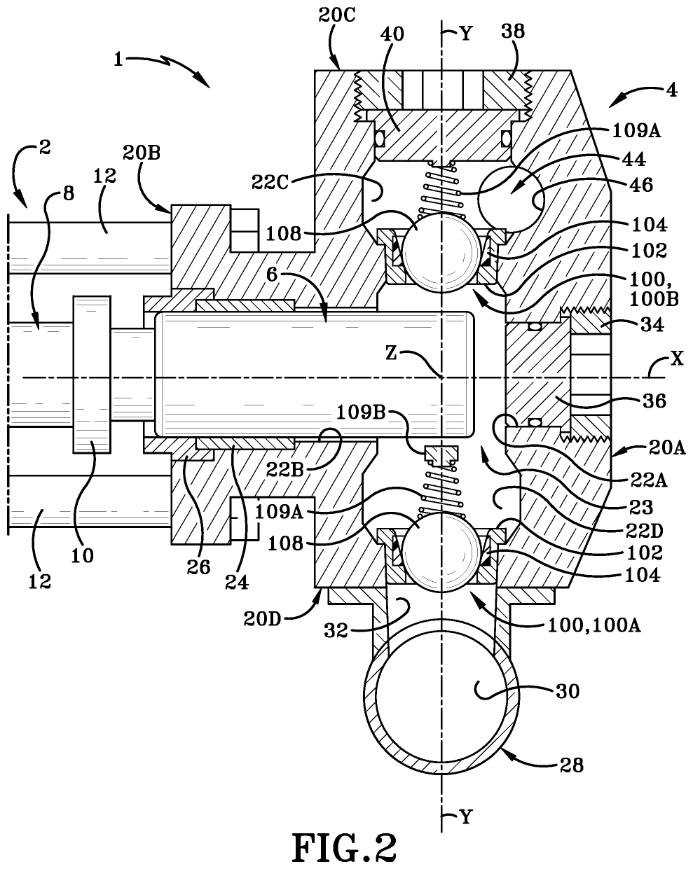

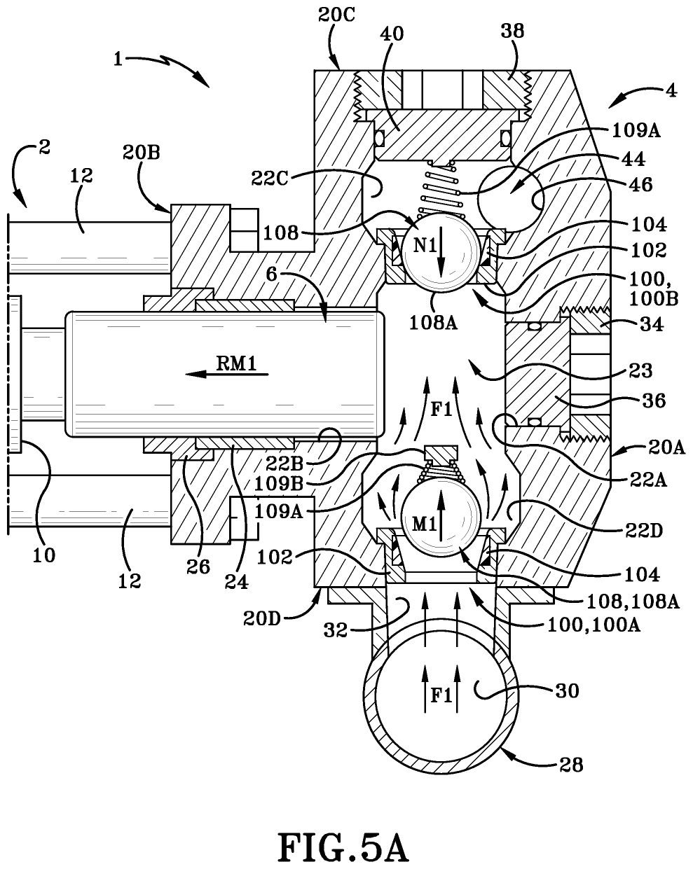

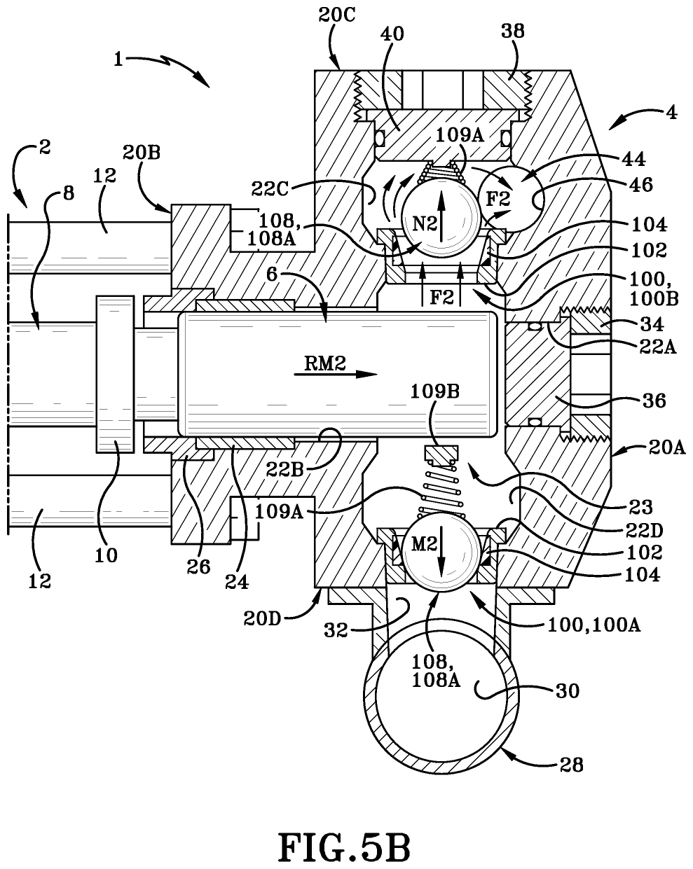

As illustrated in FIG. 2, the frac power end 2 includes a plurality of plungers 6. Each plunger of the plurality of plungers 6 is configured to be received by the frac fluid end 4 during fracturing operations for pumping and injecting frac fluid through the frac fluid end 4, which is described in more detail below. Each plunger of the plurality of plunger 6 is also configured to reciprocate between a retracted position (see FIG. 5A) and an inserted position (see FIG. 5B) via a respective drive shaft of a plurality of drive shafts 8. As illustrated in FIG. 2, a first plunger of the plurality of plungers 6 may be operably engaged with a first drive shaft of the plurality of drive shafts 8. Each drive shaft of the plurality of drive shafts 8 (such as the first drive shaft) is operably engaged to a motor or engine (not illustrated) for collectively reciprocating the plurality of plungers 6 and the plurality of drive shafts 8 together. Each drive shaft of the plurality of drive shafts 8 is also operably engaged with a respective plunger of the plurality of plungers 6 via a connector of a plurality of connectors 10. As illustrated in FIG. 2, the first drive shaft of the plurality of drive shafts 8 is operably engaged with the first plunger of the plurality of plungers 6 via a first connector of the plurality of connectors 10.

Still referring to FIG. 2, a plurality of stay rods 12 may be used to operably engage the frac power end 2 with the frac fluid end 4. As illustrated in FIG. 2, first and second stay rods may be used to operably engaged a portion of the frac power end 2 with a portion of the frac fluid end 4. While only first and second stay rods are described and illustrated herein, any suitable number of stay rods may be used to operably engage a frac power end with a frac fluid end of a slurry pump based on various considerations.

Referring to FIGS. 1 and 2, the frac fluid end 4 includes a first end or front end 20A, an opposing second end or rear end 20B, and a transverse axis “X” defined therebetween. The frac fluid end 4 also includes a third end or top end 20C, an opposing fourth end or bottom end 20D, and a vertical axis “Y” defined therebetween. The frac fluid end 4 also includes a first side or left side 20E (see FIG. 1), an opposing second side or right side 20F (see FIG. 1), and a longitudinal axis “Z” defined therebetween.

Referring to FIG. 2, the frac fluid end 4 defines a set of front or first passageways 22A that extends rearwardly from the front end 20A of the frac fluid end 4 towards the rear end 20B of the frac fluid end 4 along an axis parallel with the transverse axis “X” of the frac fluid end 4. The frac fluid end 4 also defines a set of rear or second passageways 22B that extends forwardly from the rear end 20B of the frac fluid end 4 towards the rear end 20B of the frac fluid end 4 along an axis parallel with the transverse axis “X” of the frac fluid end 4. In the illustrated embodiment, each rear passageway of the set of rear passageways 22B is coaxial with a respective front passageway of the set of front passageways 22A. Such uses of the set of front passageways 22A and the set of rear passageways 22B are described in more detail below.

Still referring to FIG. 2, the frac fluid end 4 also defines a set of top or third passageways 22C that extends downwardly from the top end 20C of the frac fluid end 4 towards the bottom end 20D of the frac fluid end 4 along an axis parallel with the vertical axis “Y” of the frac fluid end 4. The frac fluid end 4 also defines a set of bottom or fourth passageways 22D that extends upwardly from the bottom end 20D of the frac fluid end 4 towards the top end 20C of the frac fluid end 4 along an axis parallel with the vertical axis “Y” of the frac fluid end 4. In the illustrated embodiment, each bottom passageway of the set of bottom passageways 22D is coaxial with a respective top passageway of the set of top passageways 22C. Such uses of the set of top passageways 22C and the set of bottom passageways 22D are described in more detail below.

The frac fluid end 4 also defines a set of chambers 23 that is accessible by a respective front passageway of the set of front passageways 22A, a respective rear passageway of the set of rear passageways 22B, a respective top passageway of the set of top passageways 22C, and a respective bottom passageway of the set of bottom passageways 22D. As illustrated in FIG. 2, a first chamber 23A of the set of chambers 23 is accessible by a first front passageway of the set of front passageways 22A, a first rear passageway of the set of rear passageways 22B, a first top passageway of the set of top passageways 22C, and a first bottom passageway of the set of bottom passageways 22D. Such use of the set of chambers 23 is described in more detail below.

Still referring to FIG. 2, packing 24 is loaded inside each rear passageway of the set of rear passageways 22B between the frac fluid end 4 and each plunger of the plurality of plungers 6. In one instance, a first packing may be provided inside the first rear passageway of the set of rear passageways 22B between the frac fluid end 4 and the first plunger of the plurality of plungers 6. The packing 24 is considered suitable because the packing 24 allows for ease of reciprocation and sliding of each plunger in the plurality of plungers 6 during operation while preventing any frac fluid from escaping past each plunger in the plurality of plungers 6 outside of the frac fluid end 4. As such, the packing 24 provides a fluid tight seal between a plunger of the plurality of plungers 6 and the frac fluid end 4.

Still referring to FIG. 2, a packing nut 26 is also operably engaged with the frac fluid end 4 inside each rear passageway of the set of rear passageways 22B between the frac fluid end 4 and each plunger of the plurality of plungers 6. In one instance, a first packing nut may be provided inside the first rear passageway of the set of rear passageways 22B between the frac fluid end 4 and the first plunger of the plurality of plungers 6. The packing nut 26 is considered suitable because the packing nut 26 prevents the packing 24 from backing out of a respective passageway of the set of rear passageways 22B when operably engaged with the frac fluid end 4 inside of said respective passageway of the set of rear passageways 22B.

The frac fluid end 4 also includes an intake manifold 28 operably engaged with the bottom end 20D of the frac fluid end 4. The intake manifold 28 is configured to receive the frac fluid to enable to the frac pump 1 to create wellbores in geological rock formation. The intake manifold 28 is also in fluid communication with each passageway of the set of bottom passageways 22D, via an intake chamber 30 defined by the intake manifold 28, to allow the frac fluid to flow into each chamber of the plurality of chambers 23. The intake manifold 28 also defines a plurality of intake ports 32 where each intake port of the plurality of intake ports 32 is in fluid communication with a respective passageway of the set of bottom passageways 22D. As illustrated in FIG. 2, a first intake port of the plurality of intake ports 32 is in fluid communication with the first bottom passageway of the set of bottom passageways 22D. As illustrated herein, the intake manifold 28 defines three intake ports 32 to match the three bottom passageways 22D and three chambers 23 defined by the fluid frac end 4 as it is a triplex fluid pump 1. In other exemplary embodiments, any suitable number of intake ports may be defined by an intake manifold based on various considerations, including the number of bottom passageways and number of chambers defined by a fluid frac end of a slurry pump.

Still referring to FIG. 2, a threaded suction cover 34 threadably engages with the frac fluid end 4 inside each passageway of the set of front passageways 22A. A plug 36 is also operably engaged with the threaded suction cover 34 to provide a fluid tight seal between the frac fluid end 4 and the threaded suction cover 34 inside each front passageway of the set of front passageways 22A. The combination of the threaded suction cover 34 and the plug 36 threadably engaged with the frac fluid end 4 inside each front passageway of the set of front passageways 22A prevents the escapement of frac fluid from exiting any front passageway of the set of front passageways 22A during a fracturing operation. The combination of the threaded suction cover 34 and the plug 36 engaged with the frac fluid end 4 inside each front passageway of the set of front passageways 22A also directs the frac fluid from each chamber of the set of chambers 23 towards each top passageway of the set of top passageways 22C during a fracturing operation.

Still referring to FIG. 2, a valve cover 38 threadably engages with the frac fluid end 4 inside each top passageway of the set of top passageways 22C. A plug 40 is also operably engaged with the threaded suction cover 34 to provide a fluid tight seal between the frac fluid end 4 and the valve cover 38 inside each top passageway of the set of top passageways 22C. The combination of the valve cover 38 and the plug 40 threadably engaged with the frac fluid end 4 inside each passageway of the set of top passageways 22C prevents the escapement of frac fluid from exiting from any top passageway of the set of top passageways 22C during a fracturing operation. The combination of the valve cover 38 and the plug 40 engaged with the frac fluid end 4 inside each top passageway of the set of top passageways 22C also allows the frac fluid to exit through a discharge manifold of the frac fluid end 4 during a fracturing operation, which is described in more detail below.

The frac fluid end 4 also includes a discharge manifold 42 operably engaged with the top end 20C of the frac fluid end 4. The discharge manifold 42 is configured to receive the frac fluid from each top passageway of the set of top passageways 22C. The discharge manifold 42 is also in fluid communication with each top passageway of the set of top passageways 22C, via a discharge chamber 44 defined by the discharge manifold 42, to allow the frac fluid to flow from fluid frac end 4. The discharge manifold 42 also defines a plurality of discharge ports 46 where each discharge port of the plurality of discharge ports 46 is in fluid communication with a respective top passageway of the set of top passageways 22C. As illustrated in FIG. 2, a first discharge port of the plurality of discharge ports 46 is in fluid communication with the first top passageway of the set of top passageways 22C. As illustrated herein, the discharge manifold 42 defines three discharge ports 46 to match the three top passageways 22C and three chambers 23 defined by the fluid frac end 4 as the frac pump 1 is a triplex slurry pump. In other exemplary embodiments, any suitable number of discharge ports may be defined by a discharge manifold based on various considerations, including the number of top passageways and number of chambers defined by a fluid frac end of a slurry pump.

As illustrated in FIG. 2, at least one valve assembly 100 is operably engaged with the frac fluid end 4 inside each top passageway of the set of top passageways 22C and inside each bottom passageway of the set of bottom passageways 22D. In the illustrated embodiment, an intake valve assembly 100A is operably engaged with the frac fluid end 4 inside each bottom passageway of the set of bottom passageway 22D. Additionally, a discharge valve assembly 1008 is operably engaged with the frac fluid end 4 inside each top passageway of the set of top passageway 22C. As illustrated in FIG. 2, a first intake valve assembly is operably engaged with the frac fluid end 4 inside of the first bottom passageway of the set of bottom passageways 22D. Still referring to FIG. 2, a first discharge valve assembly is operably engaged with the frac fluid end 4 inside of the first top passageway of the set of top passageways 22C. As provided herein, the intake and discharge valve assemblies 100A, 1008 are substantially similar to one another and are operably engaged with the frac fluid end 4 in the substantially same orientation. Inasmuch as the valve assemblies 100A, 100B are substantially similar, the following description will relate to the intake valve assembly 100A. It should be understood, however, that the description of the intake valve assembly 100A applies substantially equally to the discharge valve assembly 1008.

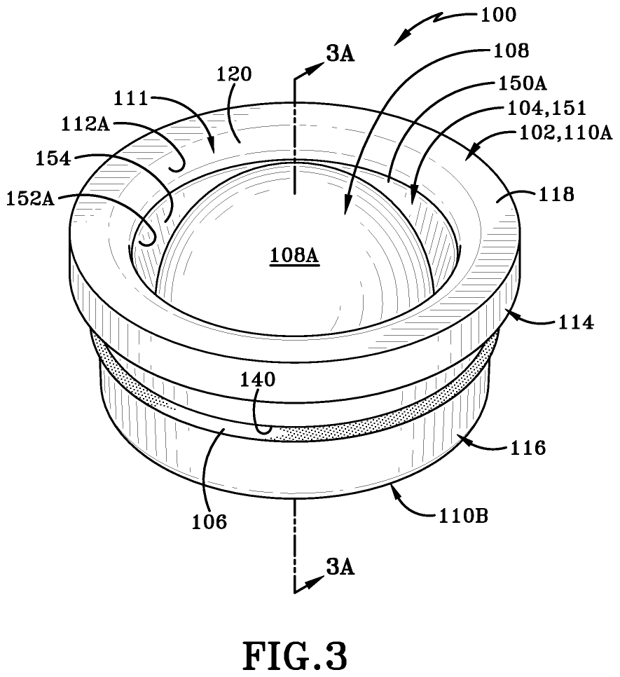

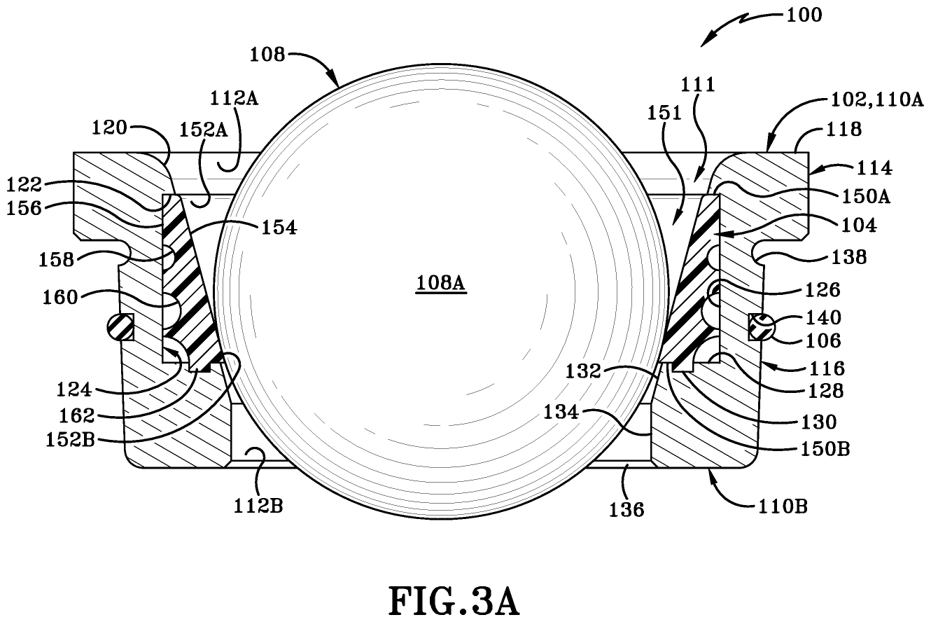

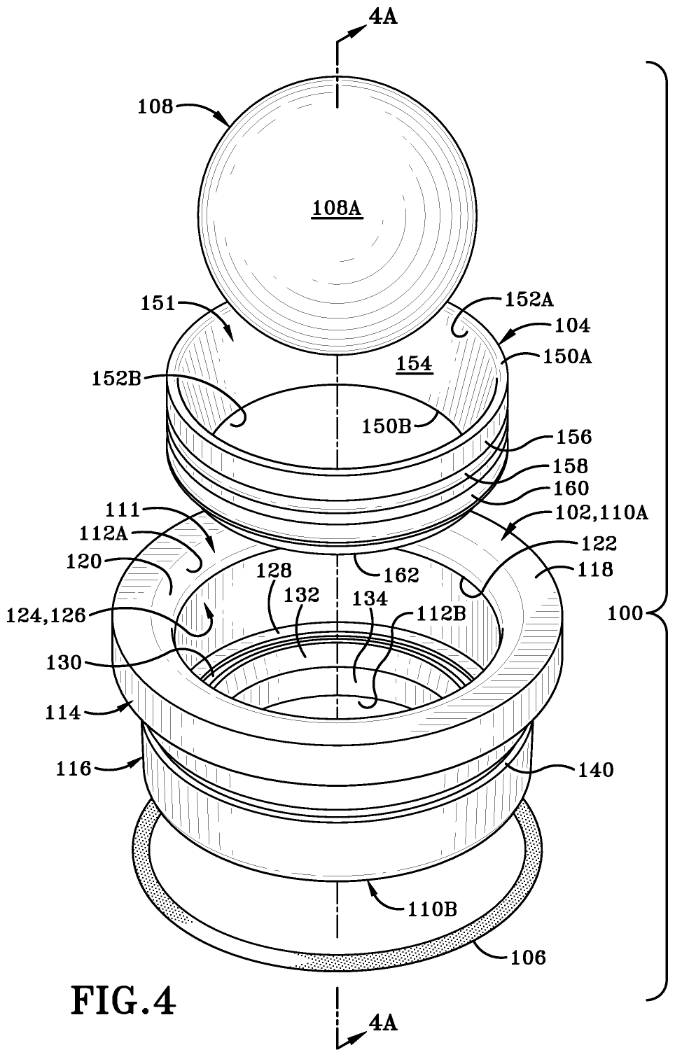

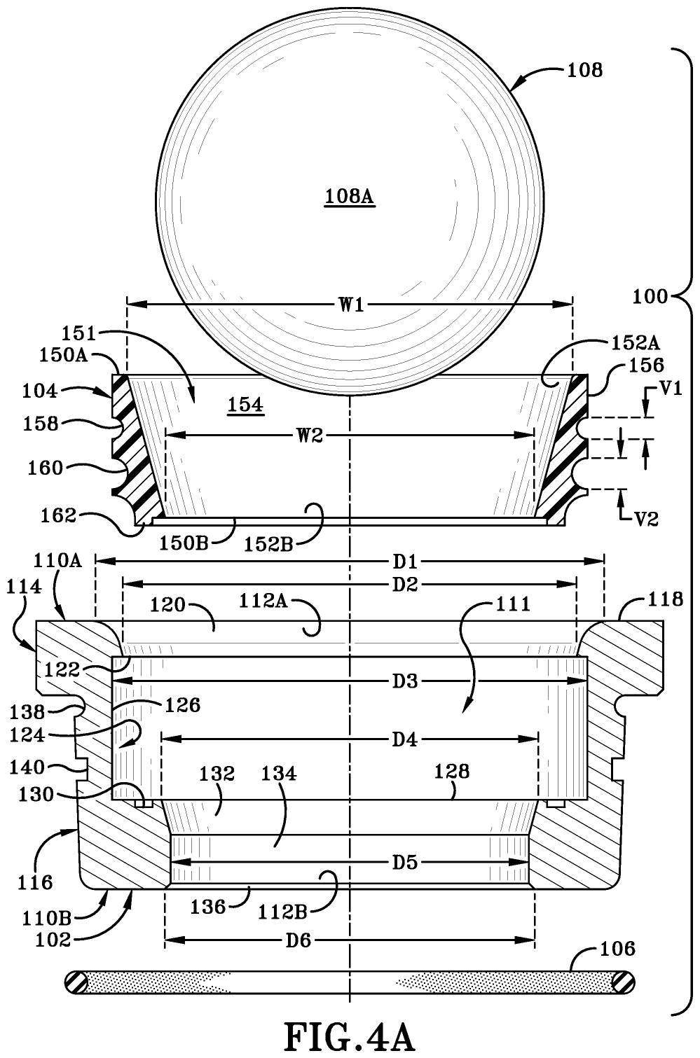

As illustrated in FIGS. 3-4A, the valve assembly 100A includes a seat 102. The seat 102 is configured to operably engage with the frac fluid end 4 inside a passageway of the set of bottom passageways 22D. The valve assembly 100A may also include an insert 104 that is operably engaged with the seat 102, particularly inside of the seat 102. The valve assembly 100A also includes a seal 106 that is operably engaged with the seat 102 remote from the insert 104. The valve assembly 100A also includes a ball valve 108 operably engaged with the seat 102 and the insert 104. As described in more detail below, the ball valve 108 is moveable between a seated position (see FIGS. 2 and FIG. 5B) and a disengaged position (see FIG. 5A) relative to the seat 102 and the insert 104 for allowing frac fluid to be drawn from the intake chamber 30 of the intake manifold 28, through the plurality of chambers 23, and into the discharge chamber 44 of the discharge manifold 42.

As illustrated in FIG. 2, a biaser 109A may operably engage with the ball valve 108 for maintaining the position of the ball valve 108 relative to the seat 102 during operation. In the illustrated embodiment, the biaser 109A is a conical-shaped compression spring. In other exemplary embodiments, any suitable biaser may be used to maintain the position of the ball valve 108 relative to the seat 102 during operation. Such use and purpose of the biaser 109A during operation is described in more detail below. Moreover, a retaining bar 109B may operably engage with the biaser 109A for providing structural support the biaser 109A is specific orientation. In one example, the retaining bar 109B may be operably engaged with an interior wall of the frac fluid end 4 inside of a bottom passageway of the set of bottom passageways 22D, which is described in more detail below. Such use and purpose of the retaining bar 109B during operation is described in more detail below. In other exemplary embodiments, a biaser and a retaining member may be omitted from a fluid end if desired by a skilled artisan.

Referring to FIG. 4A, the seat 102 includes a top end 110A, an opposing bottom end 110B, and a longitudinal axis defined therebetween. The seat 102 also defines a passage 111 from the top end 110A to the bottom end 110B extending along the longitudinal axis of the seat 102. The passage 111 is accessible via a top opening 112A defined by the seat 102 proximate the top end 110A and an opposing bottom opening 112B defined by the seat 102 proximate to the bottom end 110B. The seat 102 also includes an annular collar 114 that is positioned proximate to the top end 110A of the seat 102. The annular collar 114 may be configured to hold the seat 102 with the frac fluid end 4 inside a respective bottom passageway of the set of bottom passageways 22B, which is described in more detail below. The seat 102 also includes a base 116 operably engaged with the annular collar 114 where the annular collar 114 and the base 116 form the seat 102 as a single, unitary member.

Still referring to FIG. 4A, the annular collar 114 includes a top surface 118 at the top end 110A of the seat 102. The annular collar 114 also includes an interior rounded corner or interior fillet 120 that extends downwardly from the top surface 118 to an upper shoulder 122. In the illustrated embodiment, the interior fillet 120 defines a diameter from a range of about 30 degrees up to about 40 degrees. In one exemplary embodiment, the interior fillet 120 defines a diameter at approximately 30 degrees. In other exemplary embodiment, any suitable interior fillet of an annular collar may define suitable diameter based on various considerations, includes the size, shape, and configuration of a ball valve being using in a valve assembly. In one exemplary embodiment, an interior fillet may define any suitable angle that enables an annular collar to catch a ball valve when moving from the disengaged position to the retracted position, and vice versa, and to be free from impeding and/or hindering movement of the ball valve during a fracturing operation.

Still referring to FIG. 4A, the seat 102 may also define a recessed portion 124 where the recessed portion 124 may be defined in a portion of the annular collar 114 and/or a portion of the base 116. As illustrated in FIG. 4A, the recessed portion 124 is defined from the upper shoulder 122 to a first interior wall 126 extending downwardly from the upper shoulder 122 to an opposing lower shoulder 128. As illustrated in FIG. 3A, the recessed portion 124 of the seat 102 is configured to receive and house the insert 104 where the insert 104 operably engages with the seat 102 between the upper and lower shoulders 122, 128. Such engagement between seat 102 and the insert 104 is described in further details below. Additionally, a cavity 130 is defined in the lower shoulder 128 of the seat 102 where the cavity 130 extends downwardly into the lower shoulder 128 towards the bottom end 1108 of said seat 102. Such use of the cavity 130 is also described in more detail below.

Still referring to FIG. 4A, the base 116 of the seat 102 may also include an interior angled corner or interior chamfer 132 that extends downwardly from the lower shoulder 128 to a second interior wall 134. As illustrated in FIG. 4A, the interior chamfer 132 tapers inwardly as the interior chamfer 132 extends downwardly from lower shoulder 128 to the second interior wall 134; as such, the diameter defined proximate to the lower shoulder 128 is greater than the diameter defined proximate to the second interior wall 134. The base 116 may also include a second interior angled corner or second interior chamfer 136 that extends downwardly from the second interior wall 134 to the bottom end 1106 of the seat 102. As illustrated in FIG. 4A, the second interior chamfer 136 tapers outwardly as the second interior chamfer 136 extends downwardly from second interior wall 134 to the bottom end 1106 of the seat 102; as such, the diameter defined proximate to the second interior wall 134 is less than the diameter defined proximate to the bottom end 1106 of the seat 102.

As illustrated in FIG. 4A, the passage 111 defined by the seat 102 has at least one diameter “D” between the top and bottom ends 110A, 1106 of the seat 102. The top opening 112A of the seat 102 has a first diameter “D1” for passage 111 defined by the annular collar 114. The upper shoulder 122 of the annular collar 114 also defines a second diameter “D2” for passage 111 that is less than the first diameter “D1” of the top opening 112A. The first interior wall 126 of the base 116 also defines a third diameter “D3” for passage 111 that is greater than the second diameter “D2” and less than the first diameter “D1” of the seat 102. The lower shoulder 128 of the base 116 also defines a fourth diameter “D4” for passage 111 that is less than the first diameter “D1”, the second diameter “D2”, and the third diameter “D3” of the seat 102. The second interior wall 134 also defines a fifth diameter “D5” for passage 111 that is less than the first diameter “D1”, the second diameter “D2”, the third diameter “D3”, and the fourth diameter “D4”. The bottom opening 112B of the seat 102 has a sixth diameter “D6” for passage 111 defined by the base 116 where the sixth diameter “D6” is greater than the fifth diameter “D5” and less than the first diameter “D1”, the second diameter “D2”, the third diameter “D3”, and the fourth diameter “D4”.

Still referring to FIG. 4A, the base 116 of the seat 102 defines a first or upper exterior groove 138 proximate to the top end 110A of the seat 102 and the adjacent to the annular collar 114. The first exterior groove 138 may be configured to allow the seat 102 to operably engage with an interior wall of the frac fluid end 4 inside of a bottom passageway of the set of bottom passageways 22D. For example, as illustrated in FIG. 2, the first intake valve assembly is operably engaged with an interior of the frac fluid end 4 inside of the first exterior groove 138 of the seat 102 of the first intake valve assembly. The base 116 of the seat 102 may also define a second or lower exterior groove 140 between the top and bottoms ends 110A, 1108 remote from the annular collar 114. The second exterior groove 140 is configured to allow the seal 106 to operably engage with the seat 102 inside of said second exterior groove 140. Such use of the seal 106 provides a fluid tight seal to prevent against frac fluid escaping past the seat 102 exterior to the passage 111 of the seat 102.

In the illustrated embodiment, the first exterior groove 138 defined by the base 116 has a first cross-sectional shape, particularly a round or curvilinear shape. The second exterior groove 140 defined by the base 116 has a second cross-sectional shape, particularly a square or rectangular shape, different than the first cross-sectional shape of the first exterior groove 138. In other exemplary embodiments, a first exterior groove and a second exterior groove defined by a base of a seat may have any size, cross-sectional shape, or configuration. In one exemplary embodiment, a first exterior groove and a second exterior groove defined by a base of a seat may have the same cross-sectional shape or configuration.

Referring to FIGS. 3A and 4A, the insert 104 has a first or top end 150A, an opposing second or bottom end 150B, and a longitudinal axis defined therebetween that is parallel to the longitudinal axis of the seat 102. The insert 104 also defines a through-hole 151 from the top end 150A to the bottom end 150B. The through-hole 151 is accessible via a first or top aperture 152A defined by the insert 104 proximate the top end 150A that has a first diameter “W1” (see FIG. 4A). The through-hole 151 is also accessible via an opposing second or bottom aperture 152B defined by the insert 104 proximate to the bottom end 150B that has a second diameter “W2” (see FIG. 4A). In the illustrated embodiment, the first diameter “W1” of the top aperture 152A is greater than the second diameter “W2” of the bottom aperture 152B due to a sloped interior surface 154 of the insert 104 tapering inwardly as said sloped interior surface 154 extends downwardly from the top end 150A to the bottom end 150B. Such configuration of the insert 104 allows the insert 104 to catch the ball valve 108 when the ball valve 108 moves from a disengaged position to a seated position (see FIGS. 5A and 5B). In the illustrated embodiment, the sloped interior surface 154 defines a diameter at the top aperture 152A from a range of about 30 degrees up to about 40 degrees. In another exemplary embodiment, the sloped interior surface 154 defines a diameter at the top aperture 152A of approximately 30 degrees.

Referring to FIG. 4A, the insert 104 has an exterior surface 156 extending from the top end 150A to the bottom end 150B. The insert 104 also defines a first or upper exterior channel 158 that extends into the exterior surface 156 having a first cross-sectional shape, particularly a round or curvilinear shape, and a first diameter “V1” (see FIG. 4A). The insert 104 also defines a second or lower exterior channel 160 that extends into the exterior surface 156 having a second cross-sectional shape, particularly a round or curvilinear shape, and a second diameter “V2” (see also FIG. 4A). In the illustrated embodiment, the upper and lower exterior channels 158, 160 defined by the insert 104 have the same cross-sectional shape. Additionally, the second diameter “V2” of the lower exterior channel 160 is greater than the first diameter “V1” of the upper exterior channel 158.

In other exemplary embodiments, an upper exterior channel and a lower exterior channel defined by an insert may have any size, cross-sectional shape, or configuration. In one exemplary embodiment, an upper exterior channel and a lower exterior channel defined by an insert may have the same cross-sectional shape or configuration and the same diameter. In another exemplary embodiment, an upper exterior channel and a lower exterior channel defined by an insert may have the same cross-sectional shape or configuration, and a diameter of the upper exterior channel is greater than a diameter of the lower exterior channel.

Referring to FIGS. 3A and 4A, the insert 104 also includes an extension 162 that extends downwardly from the bottom end 1508 of the insert 104. The extension 162 is sized and configured to be received by the cavity 130 of the seat 102 to allow the extension 162 to operably engage with the seat 102.

Once assembled, the insert 104 operably engages with the seat 102 at at least one location. As illustrated in FIG. 3A, a portion of the top end 150A of the insert 104 operably engages with the upper shoulder 122 of the seat 102. The exterior surface 156 of the insert 104 also operably engages with the first interior wall 126 of the seat 102. The extension 162 of the insert 104 also operably engages with the seat 102 inside of the cavity 130, and a portion of the bottom end 1508 of the insert operably engages with the lower shoulder 128 of the seat 102. In the illustrated embodiment, the insert 104 is press-fitted into the recessed portion 124 of the seat 102 at multiple locations stated above. In other exemplary embodiments, an insert may be operably engaged with a seat inside a recessed portion defined by the seat in any suitable way.

In the illustrated embodiment, the seat 102 is a made of a first material, particularly a metal material, and the insert 104 is made of a second material, particularly a resilient and flexible material, that is different than first material of the seat 102. In particular, the second material of the insert 104 may be a synthetic polymer. Specifically, the second material of the insert 104 may be neoprene or urethane. In other exemplary embodiment, a seat and an insert of a valve assembly may be made of any suitable materials based on various considerations, including the operation conditions inside of a frac fluid end, the material and configuration of a ball valve of the valve assembly, and other various considerations of the like.

As illustrated in FIGS. 3-4A, the seal 106 operably engages with the seat 102 inside of the upper exterior groove 138. The seal 106 is made of a material that is resilient and flexible to provide a fluid tight seal between an interior surface of the frac fluid end 4 inside a passageway of the set of bottom passageways 22D and the base 116 of the seat 102. As illustrated herein, the seal 106 may be a gasket or an O-ring that that is resilient and flexible to provide a fluid tight seal between an interior surface of the frac fluid end 4 inside a passageway of the set of bottom passageways 22D and the base 116 of the seat 102.

Still referring to FIGS. 3-4A, the ball valve 108 may operably engage with the seat 102 and/or the insert 104 during fracturing operations. As illustrated in FIG. 3A, a portion of an exterior surface 108A of the ball valve 108 operably engages with and contacts the sloped interior surface 154 of the insert 104 when provided in the seated position. The configuration between the insert 104 and the ball valve 108 allows the ball valve 108 to provide a fluid tight seal when provided in the seated position so frac fluid flow from the intake manifold 28 to the discharge manifold 42 during fracturing operations. Moreover, the configuration between the insert 104 and the ball valve 108 prevents the ball valve 108 from being wedged or lodged in the insert 104 so that the ball valve 108 may move between the sealed position and the disengaged position during fracturing operations, which is described in more detail below.

In the illustrated embodiment, the ball valve 108 is spherical shaped to match with and/or to be complementary with the cylindrical shape of the seat 102 and the insert 104. Such shapes of the seat 102, the insert 104, and the ball valve 108 are considered advantageous at least because these shapes allow the frac fluid to flow through the seat 102 and the insert 104 and around the ball valve 108 with reduced turbulence and cavitation as compared to conventional stem guided valves or wing guided valves. Specifically, the ball valve 108 has a continuous and uninterrupted surface that prevents high velocity and the change of flow direction in the frac fluid when traveling through the seat 102 and around the ball valve 108 as compared to extensions or legs provided on the conventional stem guided valves or wing guided valves currently used in frac fluid ends. Such complementary shapes between the seat 102, the insert 104, and the ball valve 108 in the valve assembly 100 also reduce wears between the insert 104 and the ball valve 108 when the ball valve 108 continuously moves between the sealed position and the disengaged position as compared to extensions provided on the conventional stem guided valves or wing guided valves currently used in frac fluid ends. Such reduction in cavitation may also reduce cracking and fissures created in the frac fluid end.

The configuration between the seat 102, the insert 104, and the ball valve 108 is also considered advantageous at least because the ball valve 108 is able to move between the seated position (see FIGS. 3A and 5B) and the disengaged position (see FIGS. 5A) in any orientation as compared to the conventional stem guided valves or wing guided valves used in frac fluid ends. In other words, the ball valve 108 may seat with the insert 104 and the seat 102 in any orientation when moving between seated and disengaged positions since the ball valve 108 has a continuous and uninterrupted surface. Currently, the extensions provided on the conventional stem guided valves or wing guided valves in frac fluid ends must seat in a specific orientation in order to avoid wedging or lodging of the extensions at an improper angle inside of a respective seat of the conventional stem guided valves or wing guided valves. Such prevention in wedging or lodging between the insert 104 and the ball valve 108 prevents the frac pump 1 to lose prime causing a lack in pumping efficiency.

The configuration between the seat 102, the insert 104, and the ball valve 108 is also considered advantageous at least because the ball valve 108 is free to travel between seated and disengaged position based on the position and action of a respective plunger in the plurality of plungers 6. In other words, the ball valve 108 is not mechanically attached or engaged with a retaining member (i.e., a spring or similar retention mechanism) similar to the stem guided valves or wing guided valves. Such elimination of springs or similar retention mechanisms between the ball valve 108 and the frac fluid end 4 allows the frac pump 1 to pump efficiently since slurry mixtures or frac fluid traveling through the frac fluid end 4 will not impede or hinder the movement of the ball valve 108 as compared to the conventional tem guided valves or wing guided valves.

In other exemplary embodiments, the valve assembly 100 may have any suitable configuration as desired by the skilled artisan as to including and/or omitting certain components and/or features from a value assembly. In one exemplary embodiment, a valve assembly described and illustrated herein may omit an insert operably engaged with a seat of the valve assembly. In another exemplary embodiment, a cover may be provided of a ball of a valve assembly when an insert is omitted from the valve assembly. In another exemplary embodiment, a ball of a valve assembly may be made of a soft/resilient material when an insert is omitted from the valve assembly.

Having now described the components of the valve assembly 100, a method of use for the valve assembly 100 is described in more detail below.

The frac fluid end 4 includes an intake valve assembly 100A operably engaged with the frac fluid end 4 inside each bottom passageway of the set of bottom passageways 22D. As illustrated in FIGS. 2 and 5A-5B, a first intake valve assembly is operably engaged with the frac fluid end 4 inside the first bottom passageway of the set of bottom passageways 22D. While not illustrated herein, second and third intake valve assemblies 100A are also operably engaged with the frac fluid end 4 inside second and third bottom passageways of the set of bottom passageways 22D substantially similar to the first intake valve assembly. The frac fluid end 4 also include a discharge valve assembly 100B operably engaged with the frac fluid end 4 inside each top passageway of the set of top passageways 22C. As illustrated in FIGS. 2 and 5A-5B, a first discharge valve assembly is operably engaged with the frac fluid end 4 inside the first top passageway of the set of top passageways 22C. While not illustrated herein, second and third discharge valve assemblies 100B are also operably engaged with the frac fluid end 4 inside second and third bottom passageways of the set of top passageways 22C substantially similar to the first discharge valve assembly.

Prior to a pumping operation, the ball valves 108 of the intake and discharge valve assemblies 100A, 100B are provided in the seated position (see FIG. 2). In the seated position, a portion of each ball valve 108 is operably engaged with a portion of the interior surface 154 of each insert 104 of each intake and discharge valve assemblies 100A, 1008. In particular, a portion of each ball valve 108 is contacting a portion of the interior surface 154 of each insert 104 of each intake and discharge valve assemblies 100A, 1008. Such contact between each ball valve 108 and each insert 104 of the intake and discharge valve assemblies 100A, 100B provides a fluid tight seal to prevent frac fluid from entering into the seat 102 and insert 104 of either the intake and discharge valve assemblies 100A, 1008.

A pumping operation begins when each plunger of the plurality of plunger 6 retracts or moves away from each chamber of the set of chambers 23 of the frac fluid end 4. Such retraction of each plunger of the plurality of plungers 6 is denoted by an arrow labeled “RM1” in FIG. 5A. As illustrated in FIG. 5A, a first plunger from the plurality of plunger 6 retracts away from a first chamber 23A in the set of chambers 23 of the frac fluid end 4. Each plunger of the plurality of plungers 6 retracts away from the frac fluid end 4 via a motor or similar mechanical device in the frac power end 2 retracting a respective drive shaft of the plurality of drive shafts 8 away from the frac fluid end 4. Referring again to FIG. 5A, the first plunger of the plurality of plungers 6 retracts away from the frac fluid end 4 via the motor or similar mechanical device in the frac power end 2 retracting a first drive shaft of the plurality of drive shafts 8 away from the frac fluid end 4. Each plunger of the plurality of plungers 6 reaches its maximum retraction once a distal end of each plunger of the plurality of plungers 6 is removed from each chamber of the set of chambers 23.

Upon retraction of the plurality of plungers 6, each plunger of the plurality of plungers 6 creates a pressure differential inside each chamber of the set of chambers 23 defined in the frac fluid end 4. As each plunger of the plurality of plungers 6 retracts away from each chamber of the set of chambers 23, the air is being removed from each chamber of the set of chambers 23 causing negative pressure or a pressure differential inside each chamber of the set of chambers 23. Upon this pressure differential, the ball valve 108 of each intake valve assembly 100A is forced upwardly away from seat 102 and the insert 104 of each intake valve assembly 100A to transition from the seated position to the disengaged position. As illustrated in FIG. 5A, the ball valve 108 of the first intake valve assembly is forced upwardly, via pressure differential created by the retracted first plunger, away from seat 102 and the insert 104 of the first intake valve assembly where the ball valve 108 moves from the seated position to the disengaged position. Such movement of the ball valve 108 in each intake valve assembly 100A is denoted by an arrow labeled “M1” in FIG. 5A. As the ball valve 108 of each intake valve assembly 100A moves to the disengaged position, the frac fluid is drawn from the intake chamber 30 of the intake manifold 28 and into the set of bottom passageways 22D via intake ports 32 providing access to the intake chamber 30. Such flow of the frac fluid from the intake manifold 28 into the set of chambers 23 of the frac fluid end 4 is denoted by arrows labeled “F1” in FIG. 5A. The frac fluid flows at a first pressure when flowing from the intake chamber 30 of the intake manifold 28 into the set of bottom passageways 22D via intake ports 32 providing access to the intake chamber 30.

During operation, the biaser 109A limits the movement of the ball valve 108 of each intake ball assembly 100A relative to the seat 102 of each intake ball assembly 100A. Such limitation in movement prevents the ball valve 108 of each intake ball assembly 100A from interfering with the associated plunger 6 when moving away from the seat 102 and towards the plunger 6. Moreover, the biaser 109A may enable the ball valve 108 to move along an axis that substantially linear to prevent the ball valve 108 from improperly seating with the seat 102 when opposing force is applied to said ball valve 108, which is described in more detail below.

The pressure differential created inside each chamber of the set of chambers 23 by a respective plunger of the plurality of plungers 6 causes the ball valve 108 of each discharge valve assembly 100B to be forced downwardly into the seat 102 and the insert 104 of each discharge valve assembly 100B to maintain the seated position. As illustrated in FIG. 5A, the ball valve 108 of the first discharge valve assembly is forced downwardly, via the pressure differential created by the retracted first plunger, into seat 102 and the insert 104 of the first discharge valve assembly where the ball valve 108 is maintained in the seated position. Such movement of the ball valve 108 in each intake valve assembly 100A is denoted by an arrow labeled “N1” in FIG. 5A.

As each plunger of the plurality of plungers 6 reaches its maximum retraction, each plunger of the plurality of plungers 6 is then insert back into a respective chamber of the set of chambers 23. Such insertion of each plunger of the plurality of plungers 6 is denoted by an arrow labeled “RM2” in FIG. 5B. As illustrated in FIG. 5B, the first plunger from the plurality of plunger 6 inserts into the first chamber 23A in the set of chambers 23 of the frac fluid end 4. Each plunger of the plurality of plungers 6 is inserted into the frac fluid end 4 via the motor or similar mechanical device in the frac power end 2 pushing a respective drive shaft of the plurality of drive shafts 8 towards the frac fluid end 4. Referring again to FIG. 5B, the first plunger of the plurality of plungers 6 inserts into from the frac fluid end 4 via the motor or similar mechanical device in the frac power end 2 pushing the first drive shaft of the plurality of drive shafts 8 into the frac fluid end 4. Each plunger of the plurality of plungers 6 reaches its maximum insertion once a distal end of each plunger of the plurality of plungers 6 is adjacent to the plug 36 of the threaded suction cover 34.

Upon insertion of the plurality of plungers 6, each plunger of the plurality of plungers 6 creates a pressure differential inside each chamber of the set of chambers 23 defined in the frac fluid end 4. As each plunger of the plurality of plungers 6 inserts into each chamber of the set of chambers 23, positive pressure or a pressing force is created inside each chamber of the set of chambers 23. Upon this pressing force, the ball valve 108 of each discharge valve assembly 100B is forced upwardly away from seat 102 and the insert 104 of each intake valve assembly 100A to transition from the seated position to the disengaged position. As illustrated in FIG. 5B, the ball valve 108 of the first discharge valve assembly is forced upwardly away from seat 102 and the insert 104 of the first discharge valve assembly, via the pressing force created by the inserted first plunger, where the ball valve 108 moves from the seated position to the disengaged position. Such movement of the ball valve 108 in each discharge valve assembly 100B is denoted by an arrow labeled “N2” in FIG. 5B. As the ball valve 108 of each intake valve assembly 100A moves to the disengaged position, the frac fluid is drawn from each bottom passageway of the set of bottom passageways 22D into the discharge chamber 44 of the discharge manifold 42 via the plurality of discharge ports 46. Such flow of the frac fluid from each bottom passageway of the set of bottom passageways 22D into the discharge chamber 44 of the discharge manifold 42 via the plurality of discharge ports 46 is denoted by arrows labeled “F2” in FIG. 5B. The frac fluid flows at a second pressure that is greater than the first pressure when flowing from each bottom passageway of the set of bottom passageways 22D into the discharge chamber 44 of the discharge manifold 42 via the plurality of discharge ports 46.

During operation, the biaser 109A limits the movement of the ball valve 108 of each discharge ball assembly 100B relative to the seat 102 of each discharge ball assembly 100B. Such limitation in movement prevents the ball valve 108 of each discharge ball assembly 100B from interfering with the discharge manifold 42 when moving away from the seat 102 and towards the discharge port 46 of the discharge manifold 42. Moreover, the biaser 109A may enable the ball valve 108 to move along an axis that substantially linear to prevent the ball valve 108 from improperly seating with the seat 102 when opposing force is applied to said ball valve 108.

The pressuring force created inside each chamber of the set of chambers 23 by a respective plunger of the plurality of plungers 6 causes the ball valve 108 of each intake valve assembly 100A to be forced downwardly into the seat 102 and the insert 104 of each intake valve assembly 100A to maintain the seated position. As illustrated in FIG. 5B, the ball valve 108 of the intake valve assembly is forced downwardly into seat 102 and the insert 104 of the first intake valve assembly, via the pressing force created by the retracted first plunger, where the ball valve 108 moves from the disengaged seated position to the seated position. Such movement of the ball valve 108 in each intake valve assembly 100A is denoted by an arrow labeled “M2” in FIG. 5B.

The pumping operations described above and illustrated in FIGS. 5A-5B may be repeated any suitable number of times for injecting frac fluid into wellbores via the frac pump 1 with the valve assemblies 100 described and illustrated herein. Additionally, the plurality of plungers 6 may reciprocate between retracted position and insertion positions for any suitable number of times for injecting frac fluid into wellbores via the frac pump 1 with the valve assemblies 100 described and illustrated herein.

As described above, the complementary shapes of the seat 102, the insert 104, and the ball valve 108 are considered advantageous at least because these spherical and rounded shapes allow the frac fluid to flow through the seat 102 and the insert 104 and around the ball valve 108 with reduced turbulence and cavitation as compared to conventional stem guided valves or wing guided valves. Specifically, the ball valve 108 has a continuous and uninterrupted surface that prevents against high velocity and the change of flow direction in the frac fluid when traveling through the seat 102 and around the ball valve 108 as compared to extensions or legs provided on the conventional stem guided valves or wing guided valves currently used in frac fluid ends. As seen in FIGS. 5A and 5B, the frac fluid (see arrows “F1” and “F2”) are able to flow in a substantially linear direction or laminar flow through the seat 102 and the insert 104 and around the ball valve 108 as compared to frac fluid flowing around extensions or legs provided on the conventional stem guided valves or wing guided valves currently used in frac fluid ends.

Such complementary shapes between the seat 102, the insert 104, and the ball valve 108 in the valve assembly 100 also reduce wears between the insert 104 and the ball valve 108 when the ball valve 108 continuously moves between the sealed position and the disengaged position as compared to extensions provided on the conventional stem guided valves or wing guided valves currently used in frac fluid ends.

The smooth and rounded configuration of the insert 104 and the ball valve 108 in each valve assembly 100 prevents the ball valve 108 from cutting into or penetrating into the insert 104 during pumping operations. Such reduction in cavitation may also reduce cracking and fissures created in the frac fluid end due to the smooth and rounded configuration of the insert 104 and the ball valve 108 in each valve assembly 100.

The configuration between the seat 102, the insert 104, and the ball valve 108 is also considered advantageous at least because the ball valve 108 is able to move between the seated position (see FIGS. 3A and 5B) and the disengaged position (see FIGS. 5A) in any orientation as compared to the conventional stem guided valves or wing guided valves used in frac fluid ends. In other words, the ball valve 108 may seat with the insert 104 and the seat 102 in any orientation since the ball valve 108 has a continuous and uninterrupted surface. As illustrated in FIGS. 5A-5B, the ball valves 108 in the first intake and discharge valve assemblies 100A1, 100B1 may seat with its respective insert 104 in any suitable orientation given the geometry of the ball valve 1008. As such, the ball valves 108 in the first intake and discharge valve assemblies 100A1, 100B1 may change its orientation since the ball valves 108 may rotate or spin about an axis between seated and disengaged positions. Currently, however, the extensions provided on these conventional stem guided valves or wing guided valves in frac fluid ends must seat in a specific orientation in order to avoid wedging or lodging of the extensions at an improper angle inside of a respective seat of the conventional stem guided valves or wing guided valves. Such prevention in wedging or lodging between the insert 104 and the ball valve 108 prevents the frac pump 1 to lose prime causing a lack in pumping efficiency.

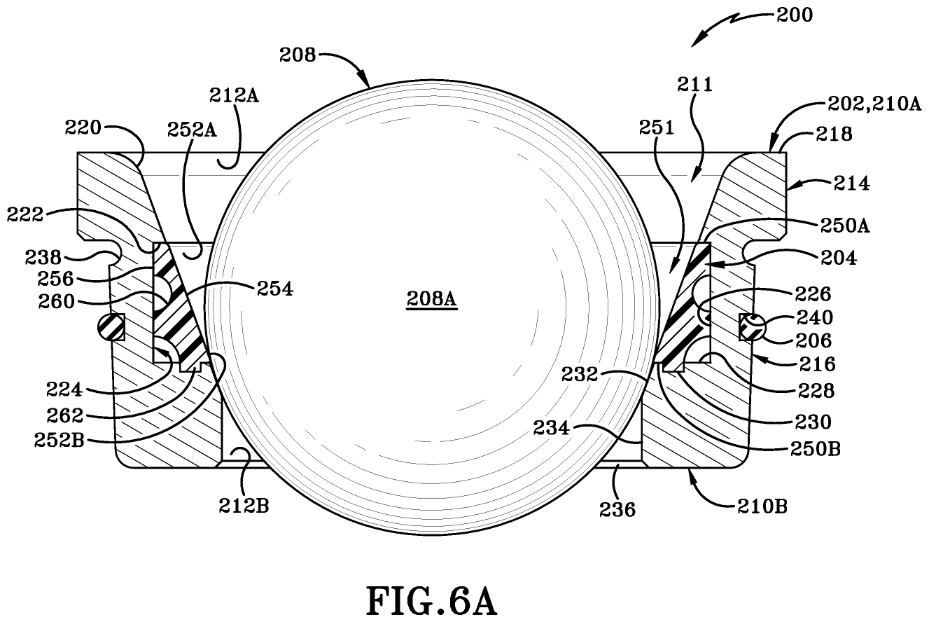

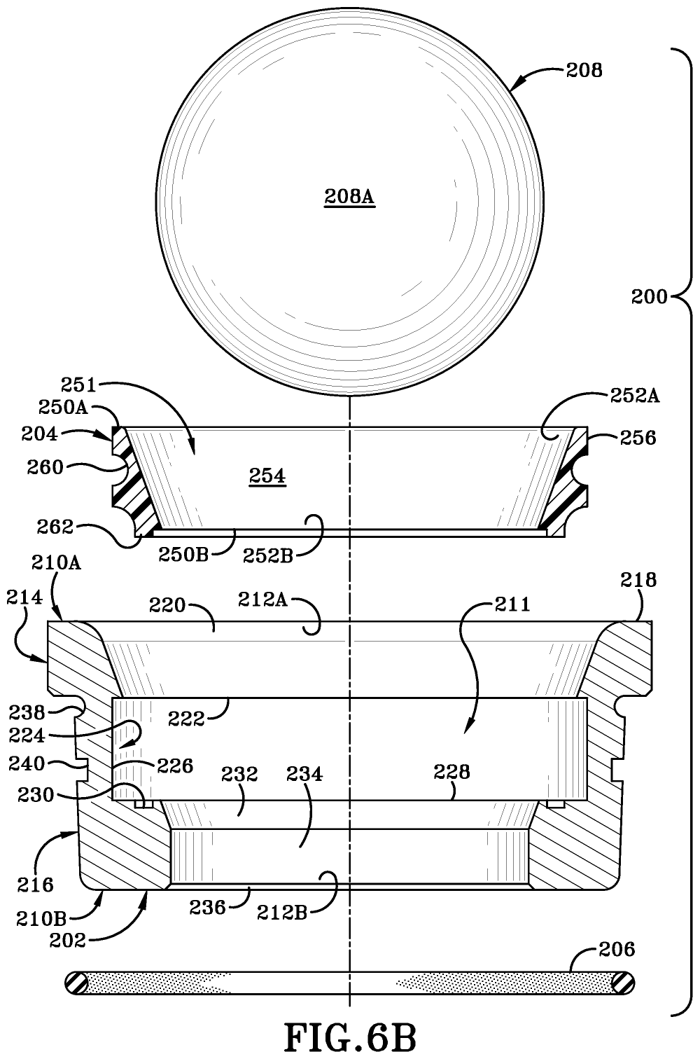

FIGS. 6A-6B illustrate an alternative ball valve assembly 200. Ball valve assembly 200 is similar to ball valve assembly 100 as described above and as illustrated in FIGS. 1-5B, except as detailed below.

As illustrated in FIGS. 6A-6B, the valve assembly 200 includes a seat 202. The seat 202 is configured to operably engage with the frac fluid end 4 inside a passageway of the set of bottom passageways 22D. The valve assembly 200 may also include an insert 204 that operably engages with the seat 202, particularly inside of the seat 202. The valve assembly 200 also includes a seal 206 that is operably engaged with the seat 202 remote from the insert 204. The valve assembly 200 also includes a ball valve 208 that operably engages with the seat 202 and the insert 204. As described above, an exterior surface 208A of the ball valve 208 is moveable between a seated position and a disengaged position relative to the seat 202 and the insert 204 for allowing frac fluid to be drawn from the intake chamber 30 of the intake manifold 28, through the plurality of chambers 23, and into the discharge chamber 44 of the discharge manifold 42.

Referring to FIG. 6B, the seat 202 includes a top end 210A, an opposing bottom end 210B, and a longitudinal axis defined therebetween. The seat 202 also defines a passage 211 that extends vertically along the longitudinal axis of the seat 102 from the top end 210A to the bottom end 210B. The passage 211 is accessible at a top opening 112A′ defined by the seat 202 proximate the top end 210A and at an opposing bottom opening 112B′ defined by the seat 202 proximate to the bottom end 210B. The seat 202 also includes an annular collar 214 that is positioned proximate to the top end 210A of the seat 202. The annular collar 214 may be configured to hold the seat 202 with the frac fluid end 4 inside a respective bottom passageway of the set of bottom passageways 22B as described above in ball valve assembly 100. The seat 202 also includes a base 216 that operably engages with the annular collar 214 where the annular collar 214 and the base 216 form the seat 202 as a single, unitary member.

Still referring to FIG. 6B, the annular collar 214 includes a top surface 218 at the top end 210A of the seat 202. The annular collar 214 also includes an interior rounded corner or interior fillet 220 that extends downwardly from the top surface 118 to an upper shoulder 222. In the illustrated embodiment, the interior fillet 220 defines a diameter from a range of about 30 degrees up to about 40 degrees. In another exemplary embodiment, the interior fillet 220 defines a diameter at approximately 40 degrees. In other exemplary embodiment, any suitable interior fillet of an annular collar may define suitable diameter based on various considerations, includes the size, shape, and configuration of a ball valve being using in a valve assembly. In one exemplary embodiment, an interior fillet may define any suitable angle that enables an annular collar to catch a ball valve when moving from the disengaged position to the retracted position, and vice versa, and to be free from impeding and/or hindering movement of the ball valve during a fracturing operation.

Still referring to FIG. 6B, the seat 202 may also define a recessed portion 224 where the recessed portion 224 may be defined in a portion of the annular collar 214 and/or a portion of the base 216. As illustrated in FIG. 6B, the recessed portion 224 is defined from the upper shoulder 222 to a first interior wall 226 extending downwardly from the upper shoulder 222 to an opposing lower shoulder 228. It should be understood that the recessed portion 224 of the seat 202 is configured to receive and house the insert 204 where the insert 204 operably engages with the seat 202 between the upper and lower shoulders 222, 228. Such engagement between seat 202 and the insert 204 is described in further detail below. Additionally, a cavity 230 is defined in the lower shoulder 228 of the seat 202 where the cavity 230 extends downwardly into the lower shoulder 228 towards the bottom end 210B of seat 202.

Still referring to FIG. 6B, the base 216 of the seat 202 may also include an interior angled corner or interior chamfer 232 that extends downwardly from the lower shoulder 228 to a second interior wall 234. As illustrated in FIG. 6B, the interior chamfer 232 tapers inwardly as the interior chamfer 232 extends downwardly from lower shoulder 228 to the second interior wall 234; as such, the diameter defined proximate to the lower shoulder 228 is greater than the diameter defined proximate to the second interior wall 234. In the illustrated embodiment, the interior chamfer 232 defines a diameter from a range of about 30 degrees up to about 40 degrees. In another exemplary embodiment, the interior chamfer 232 defines a diameter at approximately 40 degrees. The base 216 may also include a second interior angled corner or second interior chamfer 236 that extends downwardly from the second interior wall 234 to the bottom end 210B of the seat 202. As illustrated in FIG. 6B, the second interior chamfer 236 tapers outwardly as the second interior chamfer 236 extends downwardly from second interior wall 234 to the bottom end 210B of the seat 202; as such, the diameter defined proximate to the second interior wall 234 is less than the diameter defined proximate to the bottom end 210B of the seat 202.

Still referring to FIG. 6B, the base 216 of the seat 202 defines a first or upper exterior groove 238 proximate to the top end 210A of the seat 202 and the adjacent to the annular collar 214. The first exterior groove 238 may be configured to allow the seat 202 to operably engage with an interior wall of the frac fluid end 4 inside of a bottom passageway of the set of bottom passageways 22D. The base 216 of the seat 202 may also define a second or lower exterior groove 240 between the top and bottoms ends 210A, 210B remote from the annular collar 214. The second exterior groove 240 is configured to allow the seal 206 to operably engage with the seat 202 inside of said second exterior groove 240. Such use of the seal 206 provides a fluid tight seal to prevent against frac fluid escaping past the seat 202 exterior to the passage 211 of the seat 202.

In the illustrated embodiment, the first exterior groove 238 defined by the base 216 has a first cross-sectional shape, particularly a round or curvilinear shape. The second exterior groove 240 defined by the base 216 has a second cross-sectional shape, particularly a square or rectangular shape, different than the first cross-sectional shape of the first exterior groove 238. In other exemplary embodiments, a first exterior groove and a second exterior groove defined by a base of a seat may have any size, cross-sectional shape, or configuration. In one exemplary embodiment, a first exterior groove and a second exterior groove defined by a base of a seat may have the same cross-sectional shape or configuration.

Referring to FIGS. 6A-6B, the insert 204 has a first or top end 250A, an opposing second or bottom end 250B, and a longitudinal axis defined therebetween that is parallel to the longitudinal axis of the seat 202. The insert 204 also defines a through-hole 251 from the top end 250A to the bottom end 250B. The through-hole 251 is accessible via a first or top aperture 252A defined by the insert 204 proximate the top end 250A. The through-hole 251 is also accessible via an opposing second or bottom aperture 252B defined by the insert 204 proximate to the bottom end 250B. In the illustrated embodiment, a diameter defining the top aperture 252A is greater than a diameter defining the bottom aperture 252B due to a sloped interior surface 254 of the insert 204 tapering inwardly as said sloped interior surface 254 extends downwardly from the top end 250A to the bottom end 250B. Such configuration of the insert 204 allows the insert 204 to catch the ball valve 208 when the ball valve 208 moves from a disengaged position to a seated position. In the illustrated embodiment, the sloped interior surface 254 defines a diameter at the top aperture 252A from a range of about 30 degrees up to about 40 degrees. In another exemplary embodiment, the sloped interior surface 254 defines a diameter at the top aperture 252A of approximately 40 degrees.

Referring to FIG. 6B, the insert 204 has an exterior surface 256 extending from the top end 250A to the bottom end 250B. The insert 204 also defines a first or upper exterior channel 258 that extends into the exterior surface 256 having a first cross-sectional shape, particularly a round or curvilinear shape. In the illustrated embodiment, insert 204 omits a second exterior channel that was previously defined in insert 104 of ball valve assembly 100 described above and illustrated in FIG. 4A.

Referring to FIGS. 6A-6B, the insert 204 also includes an extension 262 that extends downwardly from the bottom end 250B of the insert 204. The extension 262 is sized and configured to be received by the cavity 230 of the seat 202 to allow the extension 262 to operably engage with the seat 202.

Once assembled, the insert 204 operably engages with the seat 202 at at least one location. Upon assembly, a portion of the top end 250A of the insert 204 operably engages with the upper shoulder 222 of the seat 202. The exterior surface 256 of the insert 204 also operably engages with the first interior wall 226 of the seat 202. The extension 262 of the insert 204 also operably engages with the seat 202 inside of the cavity 230, and a portion of the bottom end 250B of the insert operably engages with the lower shoulder 228 of the seat 202. In the illustrated embodiment, the insert 204 is press-fitted into the recessed portion 224 of the seat 202 at multiple locations stated above. In other exemplary embodiments, an insert may be operably engaged with a seat inside a recessed portion defined by the seat in any suitable way.

In the illustrated embodiment, the seat 202 is a made of a first material, particularly a metal material, and the insert 204 is made of a second material, particularly a resilient and flexible material, that is different than first material of the seat 202. In particular, the second material of the insert 204 may be a synthetic polymer. Specifically, the second material of the insert 204 may be neoprene, urethane, or polyurethane. In other exemplary embodiment, a seat and an insert of a valve assembly may be made of any suitable materials based on various considerations, including the operation conditions inside of a frac fluid end, the material and configuration of a ball valve of the valve assembly, and other various considerations of the like.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A ball valve assembly for a fracturing (frac) fluid end, comprising:
a seat adapted to engaged with the frac fluid end inside of at least one chamber defined by the frac fluid end;
a seal operably engaged with the seat to prevent fluid from escaping around the seat
a ball valve operably engageable inside of the seat;
wherein the ball valve is moveable between a seated position and a disengaged position relative to the seat via at least plunger of the frac fluid end to allow the fluid to travel from an intake chamber of the frac fluid end towards a discharge chamber of the frac fluid end.

2. The ball valve assembly of claim 1, further comprising:
an insert operably engaged inside of the seat and spaced apart from the seal;
wherein the insert is configured to contact the ball valve inside of the seat for preventing the ball valve from being wedged inside of the seat when moving between the seated position and the disengaged position.

3. The ball valve assembly of claim 2, further comprising:
a first material forming the seat; and
a second material forming the insert;
wherein the first material and the second material are different materials.

4. The ball valve assembly of claim 3, wherein the first material is a metal material and the second material is a resilient material made of Neoprene or urethane.

5. The ball valve assembly of claim 2, wherein the seat further comprises:
an annular collar having an interior fillet extending downwardly from a top surface of the annular collar to an upper shoulder of the annular collar;
wherein the annular collar is configured to catch the ball valve when the ball valve moves from the disengaged position to the seated position.

6. The ball valve assembly of claim 5, further comprising:
a diameter defined by the interior fillet of the annular collar;
wherein the diameter of the interior fillet is between about 30 degrees up to 40 degrees.

7. The ball valve assembly of claim 5, further comprising:
a diameter defined by the interior fillet of the annular collar;
wherein the diameter of the interior fillet is approximately 40 degrees.

8. The ball valve assembly of claim 5, further comprising:
a circumferential slot defined in the seat and positioned vertically below the annular collar; and
a circumferential extension extending away from the insert;
wherein the circumferential extension is configured to operably engaged with the seat inside of the circumferential slot.

9. The ball valve assembly of claim 5, further comprising:
an upper shoulder of the seat positioned vertically below the annular collar;
a lower shoulder of the seat vertically opposite to the upper shoulder and positioned vertically below the annular collar and the upper shoulder; and
a recessed portion defined between the upper shoulder and the lower shoulder;
wherein the insert operably engages with the upper shoulder and the lower shoulder and is housed inside of the recessed portion.

10. The ball valve assembly of claim 1, further comprising:
a circumferential groove defined in an exterior surface of the seat;
wherein the circumferential groove is configured to allow the seal to operably engaged with the seat inside of said circumferential groove.

11. The ball valve assembly of claim 1, further comprising:
a retaining bar adapted to engage with the fracturing fluid end inside of the at least one chamber; and
a biaser operably engaged with the retaining bar and the ball valve;
wherein the biaser is configured to bias the ball valve at the seated position.

12. The ball valve assembly of claim 1, further comprising:
a biaser adapted to engage with a plug of the fracturing fluid end and the ball valve;
wherein the biaser is configured to bias the ball valve at the seated position.

13. The ball valve assembly of claim 4, wherein the seat further comprises:
a top open end;
a bottom open end vertically opposite to the top open end; and
a passageway defined therebetween;
wherein when the ball valve is in the seated position, portions of the ball valve extend outwardly from the top open end and the bottom open end.

14. A method, comprising steps of:
engaging at least one ball valve assembly with an intake manifold of a fracturing (frac) fluid end of a slurry pump;
engaging at least another ball valve assembly with a discharge manifold of the frac fluid end of the slurry pump;
transitioning a ball valve of the at least one ball valve assembly from a seated positon to a disengaged position relative to a seat of the at least one ball valve assembly when at least one plunger of a plurality of plungers retracts from the frac fluid end;
transitioning a ball valve of the at least another ball valve assembly from a seated positon to a disengaged position relative to a seat of the at least another ball valve assembly when the at least one plunger inserts into the frac fluid end; and
discharging a volume of fluid through the at least one ball valve assembly and the at least another ball valve assembly.

15. The method of claim 14, further comprising:
transitioning the ball valve of the at least one ball valve assembly from the disengaged positon to the seated position relative to the seat of the at least one ball valve assembly when the at least one plunger retracts from the frac fluid end;
wherein the seat includes an annular collar having an interior fillet extending downwardly from a top surface of the annular collar to an upper shoulder of the annular collar;
wherein the interior fillet defines a diameter at approximately 40 degrees.

16. The method of claim 15, further comprising:
contacting the ball valve of the at least one ball valve assembly with an insert of the at least one ball valve assembly when the ball valve of the at least one ball valve assembly is provided in the seated position.

17. The method of claim 14, further comprising:
transitioning the ball valve of the at least another ball valve assembly from the disengaged positon to the seated position relative to the seat of the at least another ball valve assembly when the at least one plunger retracts from the frac fluid end;
wherein the seat includes an annular collar having an interior fillet extending downwardly from a top surface of the annular collar to an upper shoulder of the annular collar;
wherein the interior fillet defines a diameter at approximately 40 degrees.

18. The method of claim 17, further comprising:
contacting the ball valve of the at least another ball valve assembly with an insert of the at least another ball valve assembly when the ball valve of the at least another ball valve assembly is provided in the seated position.

19. The method of claim 14, further comprising:
biasing the ball valve of the at least one ball valve assembly, via a biaser of the at least one ball valve assembly, towards the seat of the at least one ball valve assembly.

20. The method of claim 14, further comprising:
biasing the ball valve of the at least another ball valve assembly, via a biaser of the at least another ball valve assembly, towards the seat of the at least another ball valve assembly.
